(19) United States
(12) Patent Application Publication
(10) Pub. No.: US 2015/0022539 A1
(43) Pub. Date: Jan. 22, 2015

(54) IMAGE PROCESSING DEVICE AND IMAGE PROCESSING METHOD

(71) Applicant: Samsung Display Co., Ltd., Yongin-city (KR)

(72) Inventors: Kamal HASSAN, Yongin-city (KR); Hee-Chul WHANG, Yongin-city (KR); Won-Woo JANG, Yongin-city (KR)

(73) Assignee: Samsung Display Co., Ltd., Yongin-city (KR)

(21) Appl. No.: 14/257,470

(22) Filed: Apr. 21, 2014

(30) Foreign Application Priority Data
Jul. 16, 2013 (KR) 10-2013-0083779

(51) Int. Cl. G06T 1/60

(52) U.S. Cl. CPC G06T 1/60
USPC 345/531

(57) ABSTRACT

An image processing apparatus including a display unit including pixels and more than one core processor. Each core processor includes: a diffusion module changing first pixel data of an image signal divided according to rows and then outputting it using a threshold value corresponding to the first pixel data, generating diffusion data using a difference between the changed first pixel data and the first pixel data, and changing second pixel data and third pixel data using the diffusion data; a memory storing an image signal including the image signal divided according to rows and then outputting it and the pixel data changed in the diffusion module; and a memory controller reading an image signal including pixel data changed in the diffusion module and displaying the read image signal to the display unit.

### CROSS-REFERENCE TO RELATED APPLICATION

This application claims priority from and the benefit of Korean Patent Application No. 10-2013-0083779, filed on Jul. 16, 2013, which is hereby incorporated by reference for all purposes as if fully set forth herein.

### BACKGROUND

1. Field

Exemplary embodiments of the present invention relate to an image processing device processing an image signal, and an image processing method.

2. Discussion of the Background

An image signal may be formed of pixel data. In a display device, pixels may include a red sub-pixel, a green sub-pixel, and a blue sub-pixel. When an image is displayed on a display device by an image signal, the pixels in the display device emit light according to the pixel data. Each of the pixels can display various colors by changing pixel data of the respective sub-pixels. However, image processing of pixel data may not be performed in real time without a time delay due to the capacity, the area, or the size of hardware.

In this case, an error diffusion algorithm may be applied to the image signal to display an image that is appropriate for the display device. That is, pixels can emit light with pixel data to which the error diffusion algorithm is applied through image processing.

The above information disclosed in this Background section is only for enhancement of understanding of the background of the invention and, therefore, it may contain information that does not constitute prior art.

### SUMMARY

Exemplary embodiments of the present invention provide an image processing method for processing an image signal using a plurality of core processors, and an image processing apparatus using the same.

Additional features of the invention will be set forth in the description which follows, and in part will become apparent from the description, or may be learned from practice of the invention.

Exemplary embodiments of the present invention disclose an image processing apparatus including a display unit including a plurality of pixels and a plurality of core processors. Each core processor includes: a diffusion module configured to change first pixel data of an image signal divided according to rows, and then outputting it using a threshold value corresponding to the first pixel data, generating diffusion data using a difference between the changed first pixel data and the first pixel data, and changing second pixel data and third pixel data using the diffusion data. A memory is configured to store an image signal including the image signal divided according to rows and then outputs it and the pixel data changed in the diffusion module. A memory controller is configured to read an image signal including pixel data changed in the diffusion module and to display the read image signal to the display unit.

An exemplary embodiment of the present invention also discloses an image processing method including a plurality of core processors, the method including: changing first pixel data of an image signal divided according to rows and then outputting the divided image signal using a threshold value corresponding to the first pixel data; generating diffusion data using a difference between the changed first pixel data and the first pixel data; changing second pixel data and third pixel data using the diffusion data; and outputting an image signal including the changed pixel data. The image processing method may be performed by each of the core processors corresponding to the image signal divided according to rows and then output.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate exemplary embodiments of the invention, and together with the description serve to explain the principles of the invention.

FIG. 1 is a block diagram illustrating an image processing apparatus according to an exemplary embodiment of the present invention.

FIG. 2 is a flowchart of an image processing method according to an exemplary embodiment of the present invention.

FIG. 3 is a timing diagram illustrating the operation of the image processing apparatus of FIG. 1.

FIG. 4 is a block diagram illustrating a core processor of FIG. 1.

FIG. 5 is a timing diagram illustrating the operation of the core processor of FIG. 4.

### DETAILED DESCRIPTION OF THE ILLUSTRATED EMBODIMENTS

The invention is described more fully hereinafter with reference to the accompanying drawings, in which exemplary embodiments of the invention are shown. This invention may, however, be embodied in many different forms and should not be construed as limited to the exemplary embodiments set forth herein. Rather, these exemplary embodiments are provided so that this disclosure is thorough, and will fully convey the scope of the invention to those skilled in the art. In the drawings, the size and relative sizes of elements may be exaggerated for clarity. Like reference numerals in the drawings denote like elements.

Throughout this specification and the claims that follow, when an element is referred to as being “coupled” to another element, the element may be “directly coupled” to the other element or “electrically coupled” to the other element through an intervening third element. In contrast, when an element is referred to as being “directly coupled” to another element, there are no intervening elements present. It will be understood that for the purposes of this disclosure, “at least one of X, Y, and Z” can be construed as X only, Y only, Z only, or any combination of two or more items X, Y, and Z (e.g., XYZ, XYY, YZ, ZZ).

In addition, unless explicitly described to the contrary, the word “comprise” and variations such as “comprises” or “comprising” will be understood to imply the inclusion of stated elements but not the exclusion of any other elements.

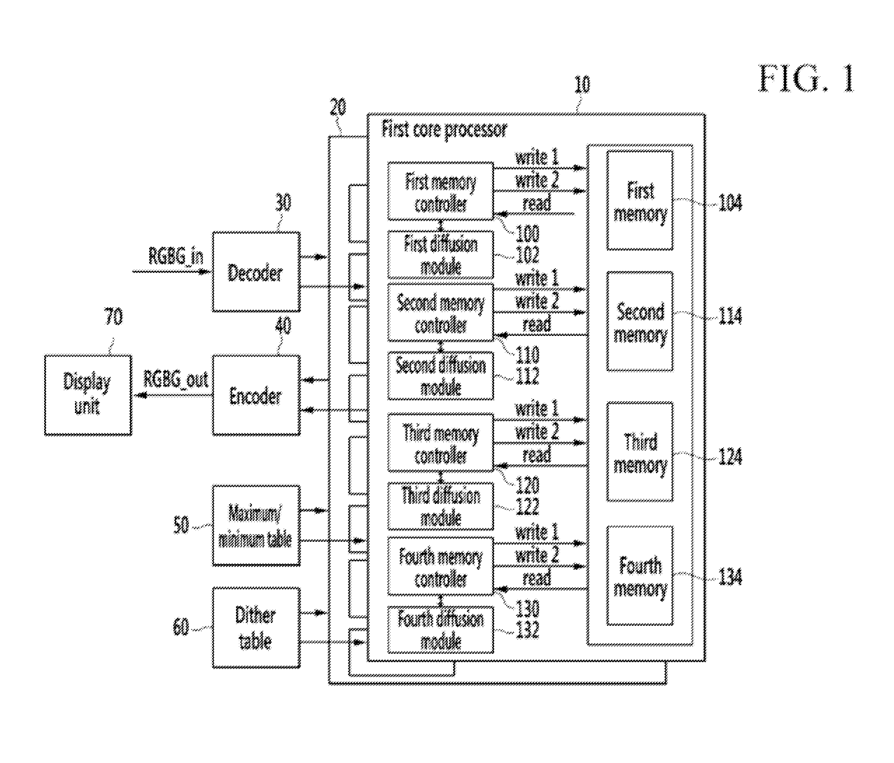

FIG. 1 is a block diagram illustrating an image processing apparatus according to an exemplary embodiment of the present invention.

As shown in FIG. 1, the image processing apparatus includes a first core processor 10, a second core processor 20, a decoder 30, an encoder 40, a maximum/minimum value table 50, and a dither value table 60. An image signal processed in the image processing apparatus is output to a display unit 70 including a plurality of pixels, and the display unit 70 displays an image by emitting light with the plurality of pixels according to the image signal.

First, the decoder 30 receives image signals, divides the received image signals according to rows, and outputs the divided image signal to each of the core processors 10 and 20. The first core processor 10 includes memory controllers 100, 110, 120, and 130; diffusion modules 102, 112, 122, and 132; and memories 104, 114, 124, and 134.

In this case, the number of memory controllers, the number of diffusion modules, and the number of memories included in each of the core processors 10 and 20 can be determined according to the number of sub-pixels included in the pixel. For example, when a pixel has a pentile structure and thus the pixel includes four sub-pixels R, G, B, and G; four memory controllers 100, 110, 120, and 130, four diffusion modules 102, 112, 122, 132, and four memories 104, 114, 124, and 134 may be included in the core processors 10 and 20.

Hereinafter, an image signal and pixel data processed by the memory controller 100, the diffusion module 102, and the memory 104 corresponding to the sub-pixel R will be described.

The memory controller 100 stores the received image signal in the memory 104 and reads the image signal stored in the memory 104. The memory controller 100 also stores an image signal modified by the diffusion module 102 in the memory 104, and reads the signal from the memory 104. Further, the memory controller 100 can output the image signal stored in the memory 104 to the diffusion module 102.

The diffusion module 102 modifies the image signal received from the memory controller 100. In this case, the diffusion module 102 can change the image signal using the maximum/minimum value table 50 and a dither value table 60. The maximum/minimum value table 50 may include maximum values and minimum values corresponding to pixel data included in the image signal. The dither value table 60 may include dither values corresponding to pixel data included in the image signal. The encoder 40 encodes an image signal output from the core processors 10 and outputs the encoded image signal to the display unit 70.

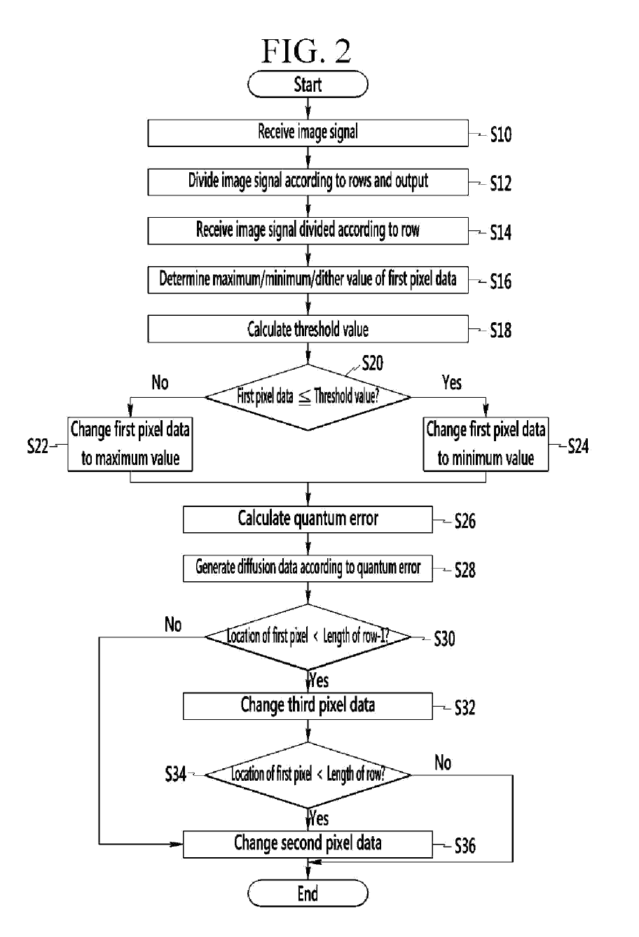

An image processing method using the image processing apparatus will be described with reference to the flowchart of FIG. 2.

Referring to FIG. 2, the decoder 30 receives an image signal (S10). Pixel data may then be arranged in a matrix format in the image signal processed according to the image processing method. For example, the image signal may include pixel data arranged in a matrix format of 1024*768. Then, the decoder 30 divides the image signal according to rows and then outputs the image signal (S12).

For example, the decoder 30 divides a first image signal, including a pixel data arranged in the N-th row, and a second image signal, including pixel data arranged in the (N+1)-th row; outputs the first image signal to the first core processor 10; and outputs the second image signal to the second core processor 20. (N is assumed to be an odd number.)

The decoder 40 may divide the image signal according to the number of core processors included in the image processing apparatus. For example, when the image processing apparatus include four core processors, the decoder 30 divides the image signal into the N-th row, the (N+1)-th row, the (N+2)-th row, and the (N+3)-th row and then outputs the image signal. Here, N may have values of 1, 5, . . . , 4K−3, and 4K may be an integer indicating the number of rows of the image signal. Then, each of the core processors 10 and 20 receives an image signal divided according to a row (S14).

Hereinafter, an image processing method performed by the first core processor 10 will be described in detail. An image signal received by the first core processor 10 may be input to the first to fourth memories 104, 114, 124, and 134 and stored therein. The image signal stored in the first memory 104 may be transmitted to the first diffusion module 102 by the first memory controller 100. The first diffusion module 102 determines a maximum value, a minimum value, and a dither value of the first pixel data (S16).

The first pixel data is pixel data included in the N-row, and is represented as P(y,x), where y denotes a height of the image signal where the first pixel data is located, and x denotes a width of the image signal where the first pixel data is located.

The first diffusion module 102 reads the maximum value and the minimum value corresponding to the first pixel data from the maximum/minimum value table 50. In addition, the first diffusion module 102 reads the dither value corresponding to the first pixel data from the dither value table 60.

The first diffusion module 102 then calculates a threshold value corresponding to the first pixel data (S18). The threshold value may be calculated as given in Equation 1.

Threshold=min(y,x)+[{max(y,x)−min (Equation 1)

Here, “Threshold” denotes a threshold value corresponding to the first pixel data, “max(y,x)” denotes a maximum value corresponding to the first pixel data, “min(y,x)” denotes a minimum value corresponding to the first pixel data, and “dither(y,x)” denotes a dither value corresponding to the first pixel data.

The first diffusion module 102 then determines whether the first pixel data is lower than the threshold value (S20). When the first pixel data is not less than the threshold value, the first diffusion module 102 changes the value of the first pixel data to the maximum value (S22). When the first pixel data is less than the threshold value, the first diffusion module 102 changes the value of the first pixel data to the minimum value (S24).

In addition, the first diffusion module 102 calculates a quantum error using the first pixel data and the changed first pixel data (S26). The quantum error can be calculated as given in Equation 2.

qerror=p(x,y)−dither_{—}p(y,x) (Equation 2)

Here, “qerror” denotes a quantum error, “p(y,x)” denotes the first pixel data, and “dither_p(y,x)” denotes the first pixel data changed to the maximum value or the minimum value.

Next, the first diffusion module 102 generates diffusion data according to the quantum error (S28). The diffusion data may be generated as given in Equation 3.

kernal=floor[kenal*qerror+0.5] (Equation 3)

Here, “kernel” is diffusion data.

The first diffusion module 102 then determines a location of a first pixel corresponding to the first pixel data (S30). The location of the first pixel may be determined using a value of x of the first pixel data and a width (i.e., 1024) of the first image signal. For example, the location of the first pixel may be determined as given in Equation 4.

x<Width−1 (Equation 4)

When the value of x satisfies Equation 4, the first diffusion module 102 changes third pixel data (S32). It is assumed that the third pixel data is pixel data corresponding to a third pixel that is separated by 2 from the first pixel in the first image signal. The first diffusion module 102 calculates diffusion data corresponding to the third pixel data using the diffusion data calculated in step S28, and adds the calculated diffusion data to the third pixel data.

When a value of the changed third pixel data exceeds a first boundary value, the first diffusion module 102 limits the value of the third pixel data to the first boundary value, and when the value of the changed third pixel data is less than a second boundary value, the first diffusion module 102 limits the value of the third pixel data to the second boundary value. When the value of the changed third pixel data is less than the first boundary value and greater than the second boundary value, the first diffusion module 102 may change the value of the third pixel data as given in Equation 5.

p(y,x+2)=floor[p(y,x+2)+0.5] (Equation 5)

Here, “p(y,x+2)” may be the third pixel data. In addition, the first diffusion module 102 again determines the location of the first pixel corresponding to the first pixel data (S34). For example, the first diffusion module 102 may determine the location of the first pixel, as given in Equation 6.

x<Width (Equation 6)

When the value of x satisfies Equation 6, the first diffusion module 102 changes second pixel data (S36). It is assumed that the second pixel data is pixel data corresponding to a second pixel that is separated by 1 from the first pixel in the first image signal.

The first diffusion module 102 calculates diffusion data corresponding to the second pixel data using the diffusion data calculated in step S28, and adds the calculated diffusion data to the second pixel data.

When a value of the changed second pixel data exceeds a first boundary value, the first diffusion module 102 limits the value of the second pixel data to the first boundary value, and when the value of the changed second pixel data is less than the second boundary value, the first diffusion module 102 limits the value of the second pixel data to the second boundary value. In addition, when the value of the changed second pixel data is less than the first boundary value and greater than the second boundary value, the first diffusion module 102 may change the value of the second pixel data as given in Equation 7.

p(y,x+1)=floor[p(y,x+1)+0.5] (Equation 7)

Here, “p(y,x+1)” may be the second pixel data.

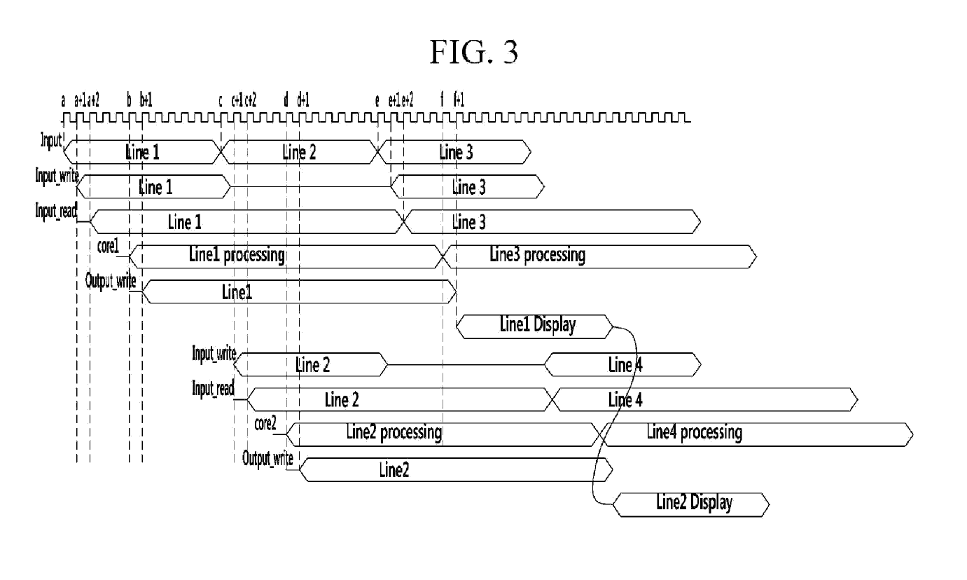

Next, timing for the image processing apparatus to process an image signal will be described with reference to FIG. 3, which is a timing diagram illustrating operation of the image processing apparatus according to an exemplary embodiment.

As shown in FIG. 3, according to a clock signal, when a first row of the image signal is input to the first core processor 10 at time a, memory controllers 100, 110, 120, and 130 of the first core processor 10 store the first row of the image signal to the respective memories 104, 114, 124, and 134 of the first core processor 10 at time (a+1). For example, pixel data corresponding to sub-pixels R, G, B, and G included in the first row of the image signal may be stored in the first to fourth memories 104, 114, 124, and 134.

Hereinafter, a description will be provided of first, second, and third rows of the image signal including a plurality of pixel data corresponding to the sub-pixels R, G, B, and G.

The memory controllers of the first core processor 10 read the first row of the image signal from the memories 104, 114, 124, and 134 of the first core processor 10 at time (a+2) and transmit the read first row to the diffusion modules 102, 112, 122, and 132 of the first core processor 10. Then, the diffusion modules 102, 112, 122, and 132 of the first core processor 10 process first pixel data of the first row of the image signal at time b, and read first pixel data processed at time (b+1) to the memories 104, 114, 124, and 134 of the first core processor 10 through the memory controllers 100, 110, 120, and 130 of the first core processor 10.

Based on the clock signal, when a second row of the image signal is stored to the second core processor 20 at time c, memory controllers of the second core processor 20 write the second row of the image signal to memories of the second core processor 20 at time (c+1).

The memory controllers of the second core processor 20 then read the second row of the image signal from the memories of the second core processor 20 at time (c+2), and transmit the read second row to diffusion modules of the second core processor 20. The diffusion modules of the second core processor 20 then process first pixel data of the second row of the image signal at time d and write the first pixel data processed at time (d+1) to the memories 104, 114, 124, and 134 of the first pixel data of the first core processor 10 through the memory controllers 100, 110, 120, and 130 of the first core processor 10.

According to the clock signal, when a third row of the image signal is input to the first core processor 10 at time e, the memory controllers 100, 110, 120, and 130 of the first core processor 10 write the third row of the image signal to the memories 104, 114, 124, and 134 of the first core processor 10 at time (e+1).

The memory controllers 100, 110, 120, and 130 of the first core processor 10 then read the third row of the image signal from the memories 104, 114, 124, and 134 of the first core processor 10 at time (e+2), and transmit the read third row to the diffusion modules 102, 112, 122, and 132 of the first core processor 10.

The diffusion modules 102, 112, 122, and 132 of the first core processor 10 then process the first pixel data of the first row of the image signal at time f, and write the first pixel data processed at time (f+1) to the memories 104, 114, 124, and 134 of the first core processor 10 through the memory controllers 100, 110, 120, and 130.

In this case, when pixel data of a first row of image signals processed in the diffusion modules 102, 112, 122, and 132 of the first core process 10 are written to the memories 104, 114, 124, and 134 of the first core processor 10, the memory controllers 100, 110, 120, and 130 of the first core processor 10 output to the encoder 40 the first row of the image signals that have been written to the memories 104, 114, 124, and 134.

The encoder 40 then encodes the first rows of the image signal respectively corresponding to the sub-pixels RGBG output from the respective memory controllers 100, 110, 120, and 130 and outputs them to the encoded first rows to the display unit 70. That is, the first core processor 10 performs image processing on pixel data included in the N-th row of the image signal when N is an odd number, and separately from this, the second core processor 20 performs image processing on pixel data included in the (N+1)-th row of the image signal.

Thus, when the image signal is simultaneously processed by two core processors and, thus, displayed to the display unit 70, the display unit 70 controls pixels corresponding to the image signal to emit light according to the output image signal.

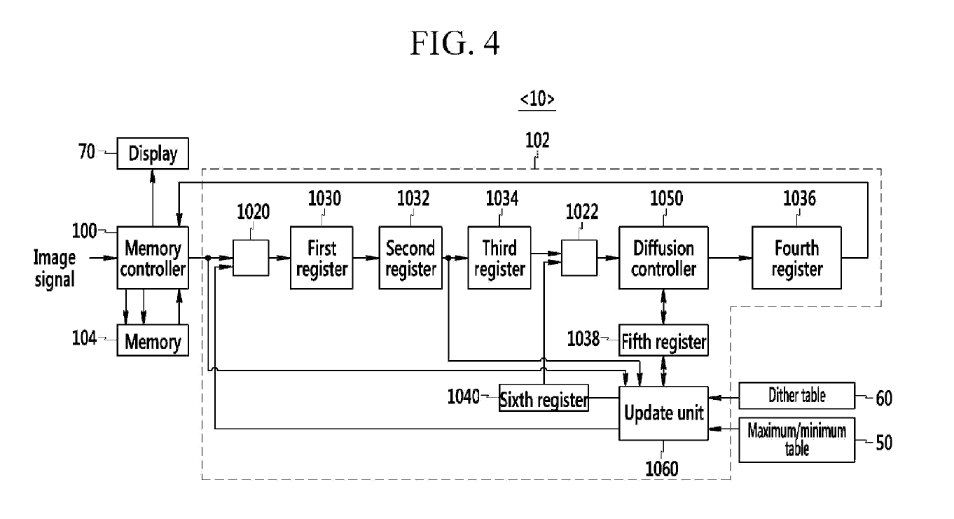

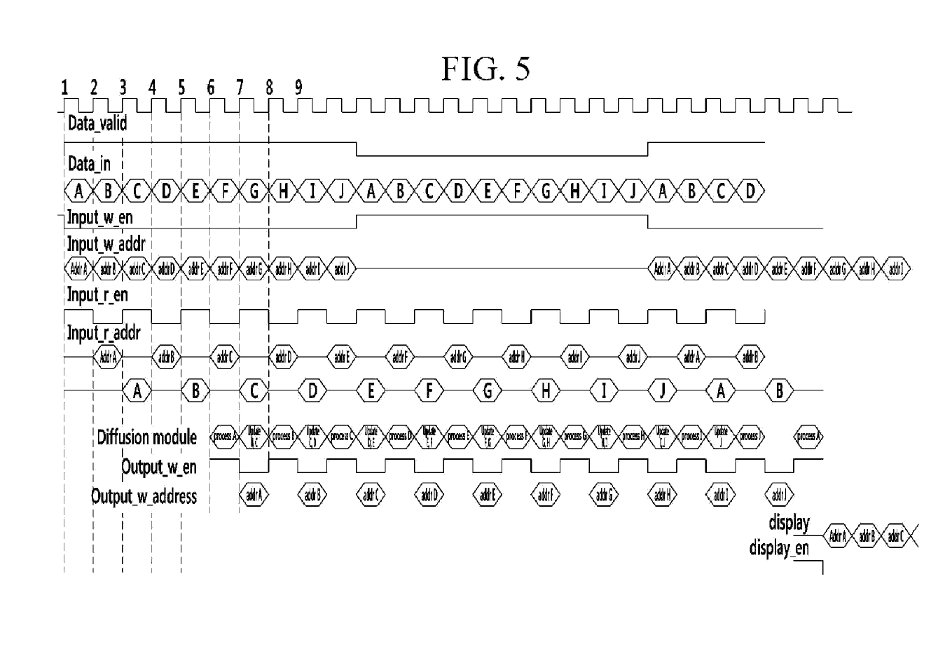

Next, referring to FIG. 4 and FIG. 5, the core processor 10 and an image processing process of the core processor 10 will be described in detail.

FIG. 4 is a block diagram illustrating a configuration of the core processor 10 of the image processing apparatus according to the exemplary embodiment of FIG. 1, and FIG. 5 is a timing diagram illustrating operation of the core processor 10 according to the exemplary embodiment of FIG. 4.

As shown in FIG. 4, the core processor 10 includes a memory controller 100, a diffusion module 102, and a memory 104.

In addition, the diffusion module 102 includes first through sixth registers 1030, 1032, 1034, 1036, 1038, and 1040, first and second data adding units 1020 and 1022, a diffusion controller 1050, and an update unit 1060. It is assumed that the first row of the image signal processed by the core processor 10 includes A to J pixel data.

As shown in FIG. 5, when pixel data A is input according to a first clock signal, the memory controller 100 writes the pixel data A to the memory 104.

When pixel data B is input according to a second clock signal, the memory controller 100 writes the pixel data B to the memory 104.

According to the second clock signal, the memory controller 100 reads the pixel data A stored in the memory 104 and transmits it to the first register 1030. In this case, since no data output from the update unit 1060 is input to the first data adding unit 1020, the pixel data A is written to the first register 1030.

The pixel data A is then transmitted to the update unit 1060 of the diffusion module 102, and the update unit 1060 reads a maximum value, a minimum value, and a dither value corresponding to the pixel data A.

According to a third clock signal, the first register 1030 then transmits the pixel data A to the second register 1032. In this case, pixel data C may be written to the memory 104. The update unit 1060 also writes the read maximum value, minimum value, and dither value to the fifth register 1038.

According to a fourth clock signal, the memory controller 100 reads the pixel data B stored in the memory 104 and transmits the read pixel data B to the first register 1030, and the second register 1032 transmits the pixel data A to the third register 1034. The diffusion controller 1050 calculates a threshold value corresponding to the first pixel data using the maximum value, the minimum value, and the dither value output from the fifth register 1038.

According to a fifth clock signal, the first register 1030 then transmits the pixel data B to the second register 1032, and the third register 1034 transmits the pixel data A to the diffusion controller 1050.

According to a sixth clock signal, the diffusion controller 1050 changes the pixel data A through the minimum value, the maximum value, and the threshold value, as described above with reference to FIG. 2.

The diffusion controller 1050 transmits diffusion data corresponding to the pixel data C to the first data adding unit 1020 through the fifth register 1038 and update unit 1060, and the pixel data C changed by the first data adding unit 1020 is written to the first register 1030. Meanwhile, the second register 1032 transmits the pixel data B to the third register 1034. In this case, the diffusion controller 1050 writes diffusion data corresponding to the pixel data B to the sixth register 1040 through the update unit 1060.

According to a seventh clock signal, the diffusion controller 1050 then writes the changed pixel data A to the fourth register 1036. In this case, the pixel data B is added to diffusion data corresponding to the pixel data B output from the sixth register 1040 in a second data adding unit 1022 and then output to the diffusion controller 1050. The diffusion controller 1050 can then change the pixel data B to which the diffusion data is added, as described above with reference to FIG. 2, through the minimum value, the maximum value, and the threshold value.

Next, according to an eighth clock signal, the diffusion controller 1050 writes the changed pixel data B to the fourth register 1036.

The diffusion controller 1050 transmits diffusion data corresponding to pixel data D to the first data adding unit 1020 through the fifth register 1038 and update unit 1060, and the pixel data D changed in the first data adding unit 1020 is written to the first register 1030.

The second register 1032 transmits the pixel data C to the third register 1034. The diffusion controller 1050 writes diffusion data corresponding to the pixel data C to the sixth register 1040 through the update unit 1060. Further, the pixel data A written to the fourth register 1036 is output to the memory 10 and then written thereto.

The pixel data image-processed by the diffusion module 102 is written to the memory 104, and then output to the display unit 70 according to a display signal. Through the above-described image processing method, the pixel data can be image-processed in the core processor 10.

It will be apparent to those skilled in the art that various modifications and variations can be made in the present invention without departing from the spirit or scope of the invention. Thus, it is intended that the present invention cover the modifications and variations of this invention provided they come within the scope of the appended claims and their equivalents.

What is claimed is:

1. An image processing apparatus comprising
a display unit comprising pixels, and
core processors, each core processor comprising:
a diffusion module configured to change first pixel data of an image signal divided according to rows and then outputting the changed first pixel data using a threshold value corresponding to the first pixel data, generate diffusion data using a difference between the changed first pixel data and the first pixel data, and change second pixel data and third pixel data using the diffusion data;
a memory configured to store the divided image signal and then output the divided image signal and the pixel data changed in the diffusion module; and
a memory controller configured to read the changed pixel data and to display the read image signal in the display unit.

2. The image processing apparatus of claim 1, wherein the diffusion module comprises:
an update unit configured to determine a maximum value, a minimum value, and a dither value corresponding to the first pixel data; and
a diffusion controller configured to calculate the threshold value using the maximum value, the minimum value, and the dither value.

3. The image processing apparatus of claim 2, wherein the diffusion controller is configured to change the first pixel data to the minimum value when the first pixel data is less than the threshold value.

4. The image processing apparatus of claim 3, wherein the diffusion controller is configured to change the first pixel data to the maximum value when the first pixel data exceeds the threshold value.

5. The image processing apparatus of claim 2, wherein the diffusion controller is configured to determine a location of the first pixel data in the row, and to change the second pixel data and the third pixel data according to the determined location of the first pixel data.

6. The image processing apparatus of claim 2, wherein the update unit is configured to divide the diffusion data, and to add the divided diffusion data to at least one of the second pixel data and the third pixel data.

7. The image processing apparatus of claim 1, wherein the memory controller is configured to delay the first pixel data, the second pixel data, and the third pixel data, and to output the delayed data to the diffusion module.

8. The image processing apparatus of claim 1, further comprising a decoder configured to receive an image signal in which the pixel data are arranged in a matrix format, to divide the image signal according to rows, and then to output the divided image signal.

9. The image processing apparatus of claim 8, wherein:
the core processors comprise a first core processor and a second core processor, and
the decoder is configured to output an image signal corresponding to an n-th row to the first core processor, and to output an image signal corresponding to an (n+1)th row to the second core processor.

10. The image processing apparatus of claim 9, wherein when an image signal corresponding to the n-th row and changed in the diffusion module is output from the first core processor, an image signal corresponding to the (n+1)th row and changed in the diffusion module is output from the second core processor.

11. The image processing apparatus of claim 1, wherein the pixel comprises sub-pixels arranged in a pentile structure.

12. The image processing apparatus of claim 11, wherein the number of diffusion modules, the number of memories, and the number of memory controllers in one of the core processors are determined according to the number of sub-pixels in the pixel.

13. An image processing method comprising:
dividing an image signal according to rows and outputting the divided image signal to different core processors;
in each core processor, changing first pixel data of the divided image signal using a threshold value corresponding to the first pixel data, and then outputting the changed pixel data;
generating diffusion data using a difference between the changed first pixel data and the first pixel data;
changing second pixel data and third pixel data using the diffusion data; and
outputting an image signal comprising the changed pixel data,
wherein each of the core processors performs the image processing method, and then outputs the processed image signal.

14. The image processing method of claim 13, wherein the changing the first pixel data comprises determining a maximum value, a minimum value, and a dither value corresponding to the first pixel data.

15. The image processing method of claim 14, wherein the changing the first pixel data further comprises calculating the threshold value using the maximum value, the minimum value, and the dither value.

16. The image processing method of claim 15, wherein the changing the first pixel data further comprises changing the first pixel data to the minimum value when the first pixel data is less than the threshold value.

17. The image processing method of claim 16, wherein the changing the first pixel data further comprises changing the first pixel data to the maximum value when the first pixel data exceeds the threshold value.

18. The image processing method of claim 13, wherein the changing the second pixel data and the third pixel data comprises:
determining a location of the first pixel in the row; and
changing the second pixel data and the third pixel data according to the determined location of the first pixel data.

19. The image processing method of claim 13, wherein the changing the second pixel data and the third pixel data comprises dividing the diffusion data and adding the divided diffusion data to at least one of the second pixel data and the third pixel data.

20. The image processing method of claim 13, further comprising:
receiving an image signal in which the pixel data are arranged in a matrix format.

21. The image processing method of claim 20, wherein:
the core processors comprise a first core processor and a second core processor, and
the dividing the image signal according to rows and then outputting the image signal comprises:
outputting an image signal corresponding to the n-th row to the first core processor; and
outputting an image signal corresponding to an (n−1)th row to the second core processor.

22. The image processing method of claim 21, wherein the outputting the image signal comprising the changed pixel data comprises:
outputting the changed image signal corresponding to an n-th row by the first core processor; and
outputting the changed image signal corresponding to an (n−1)th row by the second core processor.
